(19) United States
(12) Patent Application Publication
(10) Pub. No.: US 2008/0271076 A1
(43) Pub. Date: Oct. 30, 2008

(54) Method and Apparatus for Switching Between Edge Device Resources in an SDV System

(75) Inventor: John Schlack, Quakertown, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/839,997

(22) Filed: Aug. 16, 2007

Related U.S. Application Data
(60) Provisional application No. 60/914,431, filed on Apr. 27, 2007.

(51) Int. Cl. G06F 3/00

(52) U.S. Cl. 725/39; 725/38

(57) ABSTRACT

A process is provided that may be employed by a set top terminal when a viewer is engaged in a SDV session and is required to switch from one edge device to another. The method begins when a set top terminal receives an SDV program forwarded over an access network by a first digital modulator. The SDV program is received on a first SDV channel associated with the first digital modulator. Next, a request is received to tune to a second SDV channel associated with a second digital modulator to thereby continue receiving the SDV program over the access network. The set top terminal detects an event indicating that a change from the first SDV channel to the second SDV channel will lessen disruption to a viewer of the SDV program. Finally, the set top terminal tunes to the second SDV channel.

### FIELD OF THE INVENTION

The present invention relates generally to a switched digital video system for distributing content to a subscriber over a system such as a satellite or cable television system, and more particularly to a switched digital video system that includes multiple edge device resources supplying content to the subscriber, which resources need to be reallocated during a switched digital video session in which the subscriber is viewing the content.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize the Session Manager to manage broadcast sessions. For each channel change, the subscriber will set up a broadcast session with the Session Manager, which will determine if the requested channel is already being sent to the corresponding service group that the subscriber belongs to. The subscriber will be assigned to join the existing broadcast session if the requested channel is available at the service group or assigned to a new broadcast session if the requested channel is not available at the service group. The Session Manager will negotiate with the Resource Managers to allocate resources required for the session. The edge device (e.g., a digital modulator such as a QAM modulator) needs to dynamically retrieve the MPEG single program transport stream that carries the requested broadcast program (likely via IP multicast) and generate the MPEG multiple program transport stream. As part of the session setup response message, the video tuning parameters such as frequency and MPEG program number are sent back to the subscriber to access the requested broadcast channel.

For purposes of managing the resources of the edge devices, it may sometimes be important to move viewers from one edge device to another even during a SDV session. Unfortunately, this can be disruptive to the viewer because there can be a short delay (e.g., a few seconds) while the switch to the new edge device is performed.

Accordingly, it would be desirable to provide a method and apparatus for switching a set top terminal during an SDV session from receiving a program on one edge device to receiving the program on another edge device with minimal viewer impact. This would allow the SDV system to better manage the resources of its edge devices.

### BRIEF DESCRIPTION OF THE DRAWINGS

FIG. 1 shows one example of a system architecture for delivering switched digital video content to a subscriber.

FIG. 2 shows one example of headend 110.

FIG. 3 shows one example of a set top terminal.

FIG. 4 shows a LAN over which two set top terminals communicate.

FIG. 5 is a flowchart showing one example of a process that may be employed by a set top terminal when a viewer is engaged in a SDV session and is required to switch from one edge device to another.

FIG. 6 shows an example of a set top terminal that includes two tuners.

FIG. 7 is a flowchart showing another example of a process that may be employed by a set top terminal when a viewer is engaged in a SDV session and is required to switch from one edge device to another.

### DETAILED DESCRIPTION

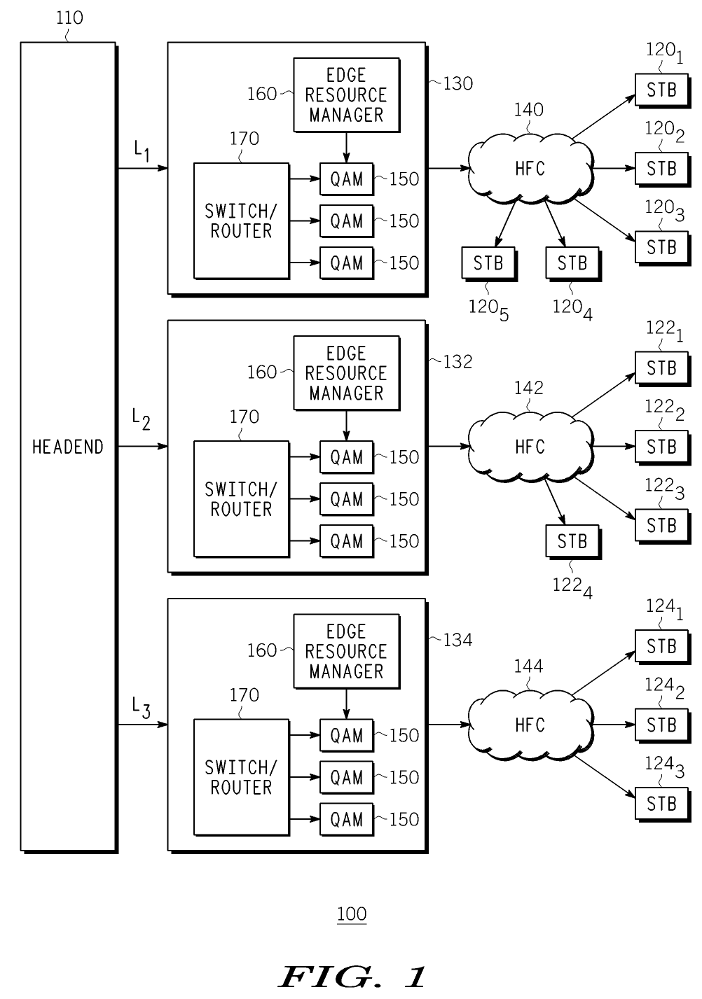

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicate with end user equipment as illustrated. In particular hubs 130, 132 and 134 in FIG. 1 communicate with access networks 140, 142 and 144, respectively. Each access network 140, 142 and 144 in turn communicates with multiple end user devices such as set top terminals. In the example of FIG. 1, access network 140 communicates with set top terminals 120₁, 120₂, 120₃, 120₄ and 120₅, access network 142 communicates with set top terminals 122₁, 122₂, 122₃, 122₄, and access network 144 communicates with set top terminals 124₁, 124₂, 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110.

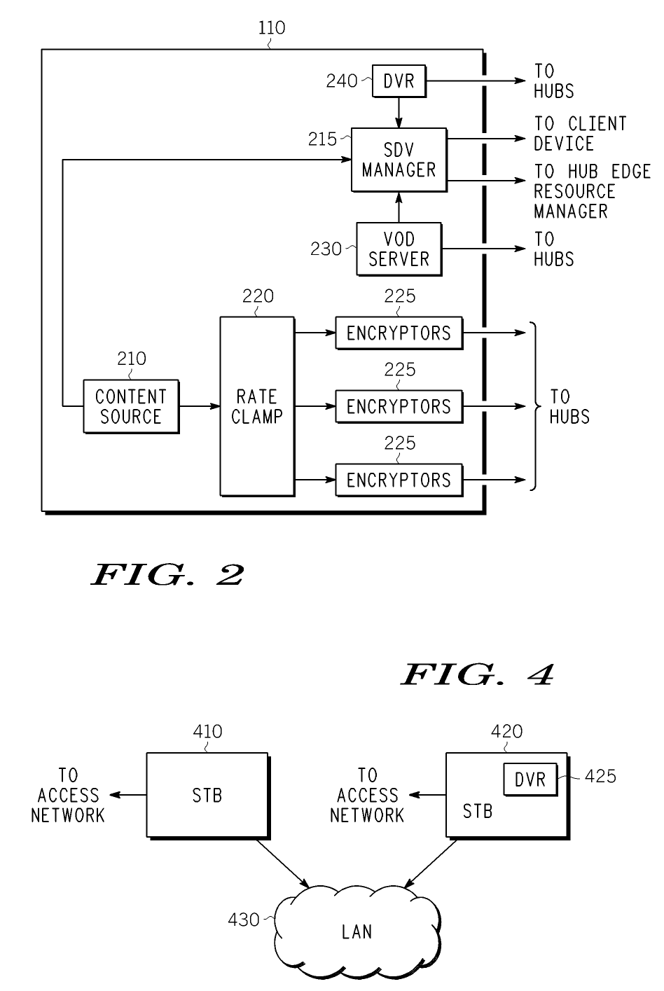

FIG. 2 shows one example of headend 110. The headend 110 includes a broadcast content source 210, which may include, by way of example, satellite receivers, off-air receivers and/or content storage devices such as servers. A SDV manager 215 is used to determine which SDV transport streams are active at any time and for directing the set top terminals to the appropriate stream. The SDV manager 215 also keeps track of which subscribers are watching which channels and it communicates with the edge resource managers 160 in the hubs so that the content can be switched on and off under the control of the SDV manager 215. In addition, all subscriber requests for a switched digital channel go through the SDV manager 215. The switched digital channels are forwarded to a rate clamp 220 and one or more encryptors 225 using, for example, IP multicast addressing. The content is then encrypted by the encryptors 225 and transmitted to the appropriate hub or hubs. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

Headend 110 may also include a network DVR 240. The network DVR 240 stores content that can be transmitted to set top terminal via a hub and access network in response to a user request to play a program stored on the DVR 240. Other user input requests are also serviced by network DVR 240, including, for example, requests to accelerate the playing of a program in the forward direction (e.g., cueing) and in the reverse direction (e.g., reviewing). The content is stored by the network DVR 240 upon a user request. The content may be provided to the network DVR 240 from any available content source, including, for example, content source 210.

Headend 110 may also include a variety of other components for offering additional services. For example, in FIG. 2 a video on demand (VOD) server 230 is shown for storing programs or other content for distribution to subscribers on an on-demand basis. Although not shown, one of ordinary skill in the art would recognize that other components and arrangements for achieving the various functionalities of headend 110 are possible. For example, the head-end 110 may comprise typical head-end components and services including a billing module, an advertising insertion module, a subscriber management system (SMS), a conditional access system and a LAN(s) for placing the various components in data communication with one another. It will also be appreciated that the head-end configuration depicted in FIG. 2 is a high-level, conceptual architecture and that each network may have multiple head-ends deployed using different architectures.

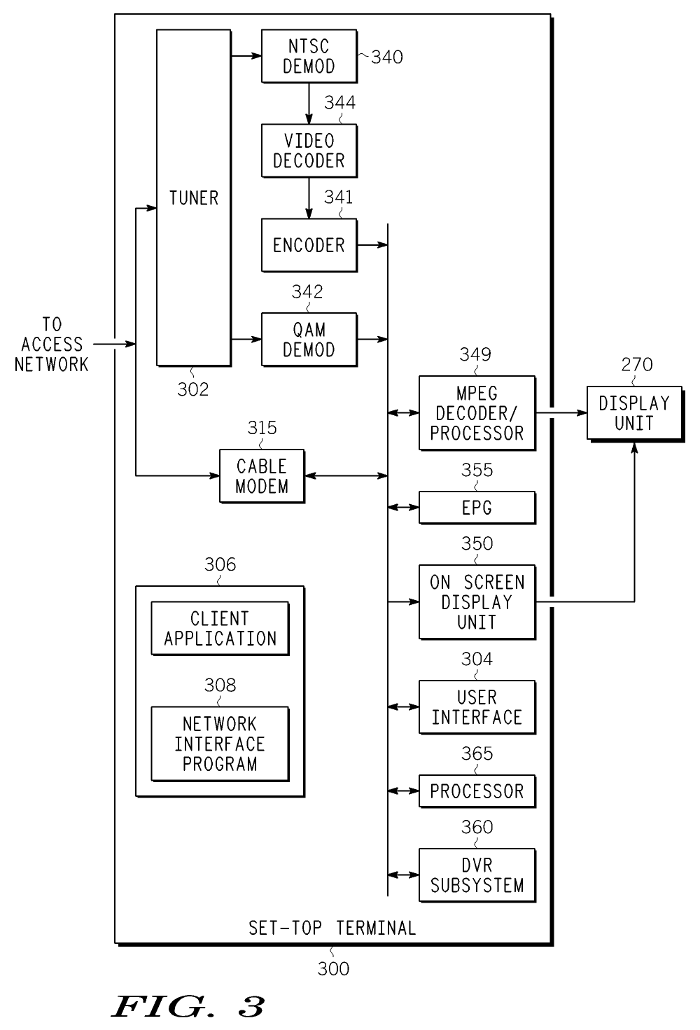

One example of a set top terminal 300 is shown in more detail in FIG. 3. It should be noted that set top terminal 300 more generally may be any apparatus such as a hardware card, specially programmed computer or other device having the functionality described herein that may be placed near to or within a television or other display device (such as a computer monitor) such as display unit 270. The set top terminal 300 receives content from cable access networks seen in FIG. 1. Broadly speaking, a traditional set top terminal such as that depicted in FIG. 3 is a device that can receive, store and forward content without manipulating the content in any significant way except to format it so that it may be rendered in a suitable manner.

Set-top terminal 300 includes an in-band tuner 302, which tunes to a channel signal selected by a consumer (not shown) via user interface 304. User interface 304 may be any control device such as a remote control, mouse, microphone, keyboard, or display. NTSC demodulator 340 and digital demodulator 342 are responsive to in-band tuner 302. NTSC demodulator 340 includes components responsive to receive analog versions of a channel signal. A digital demodulator 342, which as shown is a QAM demodulator, but, which may be any type of digital demodulator device, includes components responsive to receive digital versions of a channel signal, and to output video information. QAM demodulator 342 receives and processes digital data packets from one or more digital sources, such as a digital television signal, an MPEG transport stream, or a media stream from an external network connection, such as cable modem 315 (if available), using well-known methods and techniques. Video decoder 344 is responsive to receive and decode video information. Video information that may require format translation or modification for compatibility with capabilities of set top terminal 300 may be passed to encoder 341 for formatting. Video information that is in a format preferred for use by MPEG Decoder/Multi Media Processor 349 may be passed directly to MPEG Decoder/Multi Media Processor 349. Encoder 341 is operative to perform predetermined coding techniques (for example, MPEG-2, MPEG-4, and others) to produce an encoded video signal for transmission to MPEG Decoder/Multi Media Processor 349, or for storage. MPEG Decoder/Multi-Media Processor 349 is operative to perform predetermined coding techniques to arrange video information into displayable formats, in accordance with well-known methods and techniques. Internal arrangements of MPEG Decoder/Multi-Media Processor 349 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An electronic program guide (EPG) 355 is also provided in set-top terminal 300. The EPG 355 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 355 may display programs in a tabular format by channel and time so that the user can make selections of desired content. In some cases, instead of transmitting it along with the programming, the electronic program guide 355 may be downloaded via a telephone line, cable connection, satellite up-link, or radio broadcast antenna.

An on-screen display unit 350 is provided in set top terminal 300. The on-screen display unit 350 is used to display information such as control menus and the like as well as information received from the service provider or MSO that needs to be directly presented to the user regardless of the particular programming or channel that the user is currently viewing. In particular, on-screen display unit 350 displays the information provided by the EPG 355. Accordingly, on-screen display unit 350 can forward the information directly to the display unit 270, where it may appear as an overlay, pop up, or scrolling text ticker that is superimposed on the current programming being viewed. Alternatively, the information from the on-screen display unit 350 may even replace the current programming that appears on the display unit 270.

DVR subsystem 360 is provided for recording programs received from the access network. DVR subsystem 360 can control the channel tuned by tuner 302 and record programming on a manual or timer control basis. Additionally, the DVR subsystem 360 can buffer incoming programs to enable a view to pause or replay a portion of a live program.

Set-top terminal 300 further includes a computer-readable storage medium 306. Computer-readable storage medium 306 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 306. The applications residing on storage medium 306 may be computer programs that include software components implemented according to well-known software engineering practices for component-based software development and stored in computer-readable memories, such as storage medium 306. The applications, however, may be any signal processing methods and/or stored instructions, in one or more parts, that electronically control functions set forth herein. Storage medium 306 may also include other programs to provide additional functionality. For example, a network interface program 308 may be provided that represents aspects of the functional arrangement of various computer programs that pertain to the receipt and processing of content and other data over the broadband system 100.

In some implementations the set top terminal 300 includes a clock (not shown) that may be periodically synchronized with a clock signal received from the headend or which may be synchronized by other means.

The various components of set top terminal 300 discussed above may all operate under the overall control of a processor 365. Moreover, it is contemplated that the processor 365, tuner 302, MPEG Decoder/Processor 349, user interface 304, onscreen display unit 350 and the other components shown in FIG. 3 may each be implemented in hardware, software or a combination thereof. In addition, although the various components are shown as separate processors, it is contemplated that they may be combined and implemented as separate processes on one or more processors.

When a viewer selects an SDV channel using a set top terminal, the SDV system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃, 122₄ are assigned to QAM modulators 150 located at hub 132, and set top terminals 124₁, 124₂, 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups.

Once a set top terminal is tuned to a channel on a particular QAM modulator, it is difficult to switch the viewer to a different modulator since the time needed to accomplish the re-tuning process may impact the viewer experience. Forcing the set top terminal to switch from one QAM modulator to another will typically result in the loss of 2-3 seconds of channel viewing because of various delays, including, for example, delays caused by tuning to the new QAM modulator, acquiring an I-frame, if necessary, and the like.

Despite this problem there are several reasons it may be desirable or necessary to move viewers from one QAM modulator to another. For example, a QAM modulator may need to be taken down for maintenance purposes. In another example, multiple copies of the same SDV channel may be being delivered to the same service group (using different encoding rates, changing multicast sources, switched broadcast versus switched narrowcast, etc.) and the SDV system may wish to consolidate the viewers onto a single QAM to conserve bandwidth. As another example, because different QAM modulators may serve different sized regions (switched broadcast versus switched narrowcast), the SDV system may need to move an SDV channel between QAM modulators to achieve greater efficiencies.

A variety of approaches may be employed to reduce the impact on the subscriber arising from the need to switch to a different QAM modulator during a SDV session. For example, in one approach, the QAM modulators can be switched during a transition from a program to a commercial or during transitions between commercials. The timing of such transitions can be determined by consulting the program listings and scheduled advertising, which can be provided to the set top terminal by the SDV manager 215 along with the request to change from one QAM modulator to another. Alternatively, headend 110 can provide a clock signal to the set top terminal indicating when commercials are scheduled. The set top terminal can compare the clock signal to the time indicated by its own internal clock to determine the arrival of the commercials.

In yet another alternative, the commercial transitions can be determined by the set top terminal itself since a black screen is generally inserted into the video stream between commercials and between a program and commercials. In this case, upon receiving a signal from the SDV manager 215 to change from one QAM modulator to another, the set-top terminal can wait to make the change until it detects the black screen (by, for example, scanning the decoded image), at which point the processor 365 can direct the tuner 302 to tune to the new modulator. The original QAM modulator can be notified by the set top terminal when it has made the transition to the new QAM modulator so that the original QAM modulator can stop transmitting the SDV program. Alternatively, the SDV manager 215 can notify the set top terminal that the SDV program will be terminated on the original QAM modulator in some specified period of time (e.g., 15 minutes). In this case the set top terminal will need to transition to the new QAM modulator within this specified period of time. Although in all these various cases the viewer will still experience a 2-3 second interruption as the transition is made, its impact on the viewing experience is minimized since the retune process occurred at a boundary with a commercial.

In another approach, after receiving a request to change from one edge QAM modulator to another, the processor 365 can direct the tuner 302 to tune to the new modulator when a viewer displays the electronic program guide (EPG) using the user interface. When the program listings are displayed, the current channel is usually not visible on the display unit. The set top terminal thus can retune to the new edge QAM modulator without any viewing impact. Alternatively, in some cases the EPG may display a thumb nail of the current channel. In this case the set top terminal can retune to the new QAM modulator before displaying the thumb nail. The viewer is not likely to notice the retune since it can be performed while the EPG initializes the display. If the EPG finishes updating the display before the retune operation completes, however, the processor can instruct the on-screen display unit 350 to display either a black box in place of the thumb nail, advertising, or the last image of the SDV channel before the retune started.

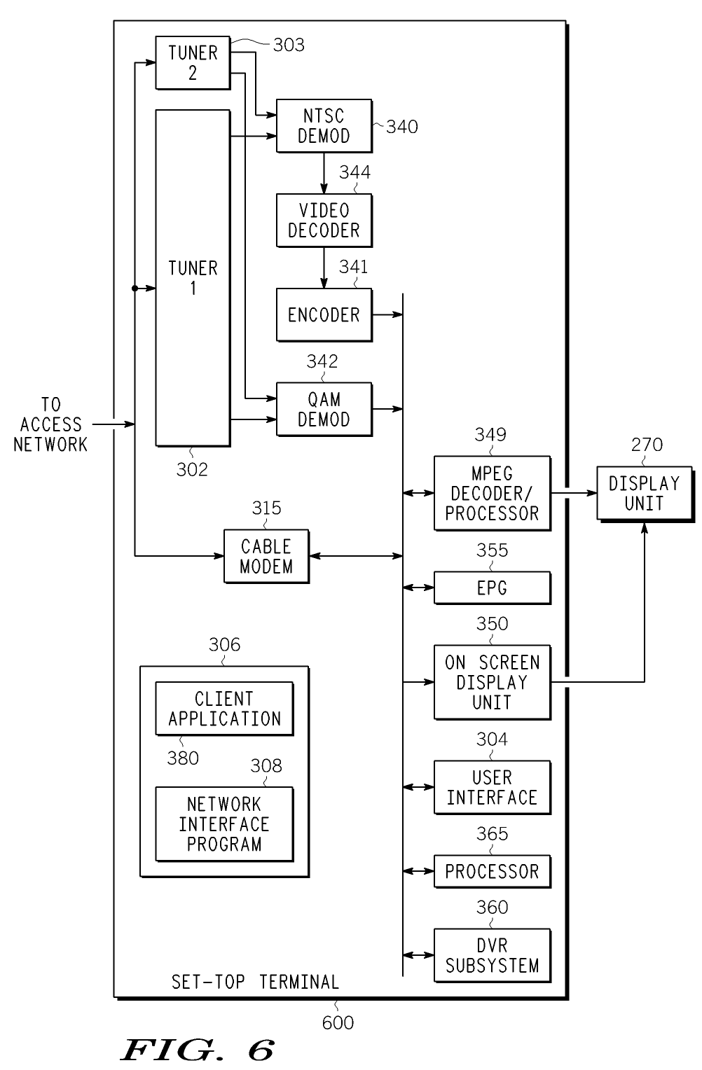

As shown in FIG. 6, many set top terminals are supplied with two or more tuners (e.g., tuners 302 and 303)) so that, for example, one program can be recorded while another program is being watched. In FIGS. 3 and 6, like elements numerals are denoted by like reference numerals. Such set top terminals can be used to reduce the impact on the subscriber when switching from one QAM modulator to another during a SDV session. In particular, if the second tuner is not being used for recording or viewing a second channel, the set top terminal can be instructed by processor 365 to tune to the new QAM on the second tuner. When the tune operation completes, the set top can swap tuners that feed the display unit 270. Once the swap is complete, the set top terminal can tune off the first QAM modulator. In some cases, to minimize interruptions, the swap could occur either during a black frame (transition between televised program and advertisement) or when a new I-Frame is received.

In another approach, the network DVR 240 shown in FIG. 2 can be used when switching from one edge device to another. When a set top terminal is instructed by the SDV manager 215 to switch to a new QAM modulator, the processor 365 in the set top terminal 150 can “pause” the current stream, thus continuing to display the last frame or image before the stream was paused. While pausing the last frame from the current QAM modulator, the SDV system begins to transmit the same frame on the new QAM modulator as many times as necessary until the retune operation completes. During this process, the network DVR system records the SDV channel so that none of the content is lost while retuning is performed. When the re-tune operation completes, the SDV system begins playing the program recorded by the network DVR 240 with the frame immediately following the frame that was paused. That is, the network DVR will begin playing the program a few seconds after it has been initially broadcast over the SDV channel. Thus, although there was an interruption of 2-3 seconds, the viewer will not miss any of the program. If the viewer were to switch off the SDV channel and then return to it at a subsequent point in time, the SDV system may present the subscriber with the current stream rather than the program recorded by the network DVR 240.

In some cases a residence or other premises has more than one television or other display, each of which requires their own set top terminal. For instance, televisions are often located in living rooms, bedrooms and kitchens. More and more such set top terminals are being networked together so that they can communicate with one another and share information so that, for instance, a program recorded by the DVR in one set top terminal can be played on a television associated with another set top terminal. Because all these devices are networked, they can share network resources. For example, an unused networked set top terminal with a DVR that resides in a bedroom can be used when switching from one edge device to another to minimize viewer disruption.

As shown in FIG. 4 set top terminals 410 and 420 located in a single residence or building may communicate with one another over a LAN 430 that operates in accordance with any of a variety of different communication standards such as Ethernet, Powerline Communication (PCL) networks, MoCA (Multimedia over Coax Alliance) and certain wireless mechanisms (e.g., 802.11, Bluetooth), which allow connectivity between different networked devices such as televisions, media centers, set top terminals, digital video recorders, stereos, computers, and appliances. The standards may be implemented in a wireless or wired manner using, for example, already installed coax cable.

If one of the set top terminals 410 and 420 that communicate over the LAN 430 includes a DVR, their tuners can be used to prevent or minimize viewer disruption of a program during a switch from one edge device to another. In the example of FIG. 4 set top terminal 420 is assumed to include a DVR 425. On the other hand, set top terminal 410 may or may not include a DVR. When the set top terminal 410 and 420 initially register with the SDV manager 215, their capabilities, including their status on the same LAN, is communicated to the SDV manager 215. In this way the SDV manager 215 can oversee and coordinate the following process in which the set top terminal 420 effectively serves as a proxy for the set top terminal 410 while the transition from one QAM modulator to another is performed. In this case, when the set top terminal 410 is being used in an SDV session and is instructed by the SDV manager 215 to switch to a new QAM modulator, the processor in the set top terminal 410, under the control of the SDV manager 215, can “pause” the current stream, thus continuing to display the last frame or image before the stream was paused. During this process, the second set top terminal 420, which is equipped with the DVR 425, is instructed to tune to the SDV channel on which the program is being supplied by the new QAM modulator so that none of the content is lost while retuning is performed. When the re-tune operation completes, the first set top terminal 410 on which the program is being viewed receives the program from the DVR 425 in the second set top terminal 420 over the LAN 430. Similar to the case in which a network DVR is employed, the DVR 425 in the second set top terminal 420 begins playing the program with the frame immediately following the frame that was paused. That is, the DVR 425 will begin playing the program a few seconds after it has been initially broadcast over the SDV channel of the new QAM modulator. Thus, although there was an interruption of 2-3 seconds, the viewer will not miss any of the program.

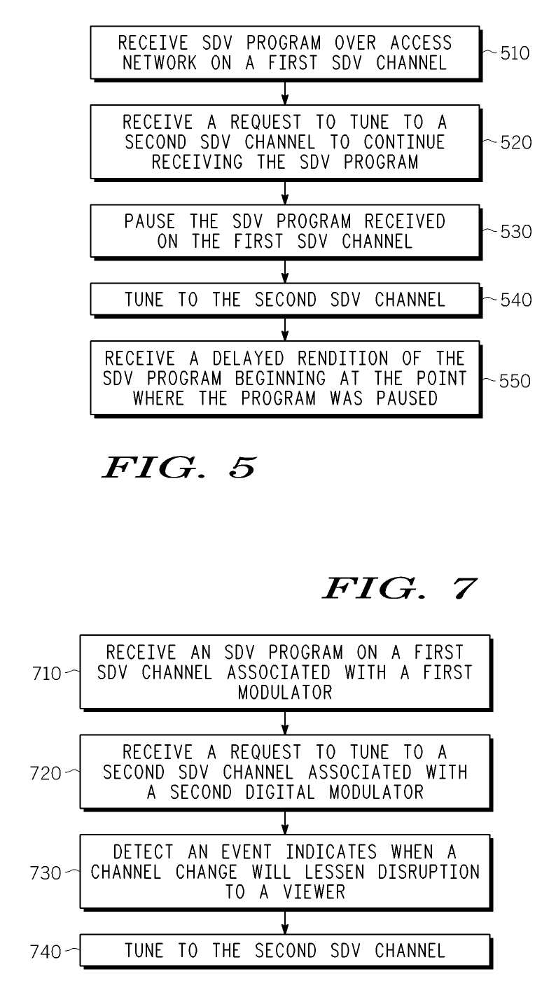

FIG. 5 is a flowchart showing one example of a process that may be employed by a set top terminal when a viewer is engaged in a SDV session and is required to switch from one edge device to another. The method begins in step 510 when the set top terminal receives an SDV program forwarded over an access network by a first digital modulator such as QAM modulator. The SDV is received on a first SDV channel associated with the first digital modulator. At some point while the program is being viewed, the set top terminal receives a request from the SDV manager in step 520 instructing it to tune to a second SDV channel associated with a second digital modulator so that it can continue receiving the SDV program over the access network. In step 530, the SDV manager instructs the set top terminal to pause the SDV program received on the first SDV channel so that a current image of the program is continuously displayed. Next, in step 540, the SDV manager also instructs the set top terminal to tune to the second SDV channel after pausing the SDV program. Finally, in step 550, a delayed rendition of the SDV program is provided to the set top terminal, beginning with the current image of the program. In this way viewer will not miss any of the program as a result of the switch from one digital modulator to another. The delayed rendition of the SDV program may be received over the access network on the second SDV channel from a network-based DVR. Alternatively, the delayed rendition of the SDV program may be received by the set top terminal over a LAN from a DVR that itself has received the delayed rendition over the access network on the second SDV channel.

FIG. 7 is a flowchart showing another example of a process that may be employed by a set top terminal when a viewer is engaged in a SDV session and is required to switch from one edge device to another. The method begins in step 710 when a set top terminal receives an SDV program forwarded over an access network by a first digital modulator. The SDV program is received on a first SDV channel associated with the first digital modulator. Next, in step 720, a request is received to tune to a second SDV channel associated with a second digital modulator to thereby continue receiving the SDV program over the access network. The set top terminal detects an event in step 730. The event indicates that a change from the first SDV channel to the second SDV channel will lessen disruption to a viewer of the SDV program. Finally, in step 740, the set top terminal tunes to the second SDV channel.

The processes described above, including but not limited to those presented in connection with the headend and set-top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving an SDV program forwarded over an access network by a first digital modulator, said SDV program being received on a first SDV channel associated with the first digital modulator;
receiving a request to tune to a second SDV channel associated with a second digital modulator to thereby continue receiving the SDV program over the access network;
detecting an event indicating that a change from the first SDV channel to the second SDV channel will lessen disruption to a viewer of the SDV program; and
tuning to the second SDV channel.

2. The computer readable medium of claim 1 wherein the SDV program is received in a quadrature amplitude modulated (QAM) signal.

3. The computer readable medium of claim 1 wherein the event that is detected is a clock value indicating that a transition is scheduled from the SDV program to a commercial or from one commercial to another commercial.

4. The computer readable medium of claim 3 wherein the clock value is scheduled is received over the access network.

5. The computer readable medium of claim 1 wherein the event that is detected is a transition from the SDV program to a commercial or from one commercial to another commercial.

6. The computer readable medium of claim 5 wherein the transition is detected using black screen detection.

7. The computer readable medium of claim 1 wherein the event that is detected is a viewer command requesting an EPG to be displayed.

8. The computer readable medium of claim 1 further comprising:
tuning to the second SDV channel while continuing to receive the SDV channel on the first SDV channel;
displaying the SDV program received on the second SDV channel;
terminating receipt of the SDV program received on the first SDV channel after initiating display of the SDV program received on the second SDV channel.

9. The computer readable medium of claim 8 wherein the event that is detected is an availability of a second tuner to receive the SDV channel on the second SDV channel.

10. At least one computer-readable medium encoded with instructions which, when executed by a processor, performs a method including:
receiving an SDV program forwarded over an access network by a first digital modulator, said SDV program being received on a first SDV channel associated with the first digital modulator;
receiving a request to tune to a second SDV channel associated with a second digital modulator to thereby continue receiving the SDV program over the access network;
pausing the SDV program received on the first SDV channel so that a current image of the program is continuously displayed;
tuning to the second SDV channel after pausing the SDV program;
receiving and displaying a delayed rendition of the SDV program beginning with the current image of the program.

11. The computer readable medium of claim 10 wherein the delayed rendition of the SDV program is received over the access network on the second SDV channel.

12. The computer readable medium of claim 11 wherein the delayed rendition of the SDV program is provided by a network-based DVR.

13. The computer readable medium of claim 10 wherein the delayed rendition of the SDV program is received over a LAN from a DVR that has received the delayed rendition over the access network on the second SDV channel.

14. The computer readable medium of claim 10 wherein tuning to the second SDV channel occurs upon detection of an event.

15. The computer readable medium of claim 14 wherein the event is a transition from the SDV program to a commercial or from one commercial to another commercial.

16. The computer readable medium of claim 10 wherein the delayed rendition of the SDV program is delayed by about an amount of time needed to tune from the first SDV channel to the second SDV channel.

17. A switched digital video (SDV) system, comprising:
a SDV manager for coordinating a SDV session requested by a subscriber terminal;
an input receiving content to be broadcast during the SDV session;
a plurality of edge devices for receiving a transport stream that includes broadcast content provided by the content source and transmitting the transport stream over an access network to the subscriber terminal on one of a plurality of SDV channels; and
wherein the SDV manager is configured to (i) request a first of the edge devices to transmit selected broadcast content to the subscriber terminal over a first SDV channel and (ii) terminate, at a subsequent time, transmission of the selected broadcast content over the first SDV channel and instead request a second of the edge devices to transmit a delayed rendition of the selected broadcast content to the subscriber terminal over a second SDV channel.

18. The SDV system of claim 17 further comprising a network-based DVR for receiving the selected broadcast content from the input and providing the delayed rendition of the selected broadcast content.

19. The SDV system of claim 17 wherein the SDV manager is further configured to instruct the subscriber terminal to (iii) pause the selected broadcast content received on the first SDV channel and (iv) tune to the second SDV manager.
